(19) United States
(12) Patent Application Publication
(10) Pub. No.: US 2008/0030514 A1
(43) Pub. Date: Feb. 7, 2008

(54) DISPLAY DEVICE

(76) Inventors: Yoshihisa Ooishi, Yokohama (JP); Junichi Maruyama, Yokohama (JP); Kikuo Ono, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/622,023

(22) Filed: Jan. 11, 2007

(30) Foreign Application Priority Data
Mar. 31, 2006 (JP) 2006-096404

(51) Int. Cl. G06T 1/60; G09G 3/36; G09G 5/10

(52) U.S. Cl. 345/530; 345/690; 345/98

(57) ABSTRACT

There is disclosed a display device which is driven by a two-field drive scheme. That is, brightness corresponding to one frame of image is obtained in two scans. The display screen is divided into plural regions. One of the regions is driven by a black insertion method. The other region is driven by a pseudo-normal drive method. In this method, an image based on the same display data is displayed twice. The display data is converted such that the gamma characteristics of the pseudo-normally driven region are substantially equal to the gamma characteristics of the region driven by the black insertion method. If necessary, each individual pixel in the boundary region between the region driven by the black insertion method and the region driven by the pseudo-normal drive method is displayed black or white. The boundary region has a width of at least two pixels.

### INCORPORATION BY REFERENCE

The present application claims priority from Japanese application JP 2006-096404 filed on Mar. 31, 2006, the content of which is hereby incorporated by reference into this application.

### BACKGROUND OF THE INVENTION

The present invention relates to a hold-type display and, more particularly, to a liquid crystal display.

Display devices are classified especially from the standpoint of the method of displaying motion picture images into two major types: impulse-type display and hold-type display. In the impulse-type display, the brightness response drops off immediately after each scan like the persistence characteristics of CRTs. In the hold-type display, brightness based on display data is maintained up to the next scan like liquid crystal displays.

One feature of the hold-type display is that it can offer good, flicker-free image quality in the case of still images. However, in the case of motion picture images, the periphery of a moving object is seen to be blurred. That is, so-called motion blurring takes place. As a result, there arises the problem that the display quality is deteriorated severely. A factor causing this motion blurring is understood as follows. As an object moves, the human observer moves his/her line of sight. At this time, display images occurring, respectively, before and after the movement, are interpolated by the observer relative to the display image whose brightness is held constant. This is known as retinal afterimage. Therefore, it is known that motion blurring cannot be fully eliminated if the response rate of the display device is improved as much as possible. According to Taiichiro Kurita, “Moving Picture Quality Improvement for Hold-type AM-LCDs”, SID 01 DIGEST, it is known that this problem can be effectively solved by refreshing the displayed image at shorter intervals of time or bringing the hold-type display close to the impulse-type display by inserting a black frame of image to cancel the retinal afterimage once.

Furthermore, U.S. Patent Publication No. 2004/0155847 (corresponding to JP-A-2004-240317) describes a technique for improving the visibility of motion picture images. In particular, one frame period is divided into first and second subperiods. Pixel data to be written into pixels during the frame period are totally written only during the first subperiod.

At this time, writing values to be written to the pixels are doubled relative to the values of the image data to prevent the brightness of the whole image from decreasing. Only when the doubled values exceed the displayable range, the remaining pixel data are written during the second subperiod. In this way, variations in the display brightness are brought closer to those of the impulse-type display.

Television receivers are typical display devices that are required to display motion picture images. For example, the scanning frequency is 60 Hz in interlaced scanning for NTSC signals. The frequency is 50 Hz in sequential scanning for PAL signals. In this way, normalized signals are used. Where the frame frequency of displayed images created based on such frequency is set to 60 Hz or 50 Hz, the motion picture images are blurred, because the frequency is not sufficiently high.

A means for alleviating the motion blurring is a technique for refreshing the image at shorter intervals of time than the above-described intervals and disclosed in U.S. Patent Publication No. 2004/0101058 (corresponding to JP-A-2005-6275). In this technique, the scanning frequency is increased. Data about interpolation frames to be displayed is created based on interframe display data, and the image refresh rate is increased. This is hereinafter abbreviated as the method of creating interframes. A technique for inserting black frames between actually displayed frames of image is described in U.S. Pat. No. 7,027,018 (corresponding to JP-A-2003-280599). This is hereinafter abbreviated as black frame insertion. U.S. Patent Publication No. 2002/0067332 (corresponding to JP-A-2003-50569) describes a technique of repeatedly turning on and off a backlight. This is hereinafter abbreviated as backlight blinking.

Where motion blurring is lessened by making use of any of these techniques, it is difficult to discern the effect of the motion blur reduction technique on actual images, because the direction of motion is not fixed and thus motion of the line of sight is not fixed.

Accordingly, as a method of making the effect of a motion blur reduction technique more easily perceptible, a hold-type display adopting a drive method having excellent motion picture characteristics and another hold-type display adopting a normal drive method are prepared, and a so-called image scrolling screen on which the direction of motion of line of sight and the velocity of motion of line of sight are kept constant at all times is displayed. Thus, their differences are made more conspicuous. The effects can be effectively gauged.

However, in order to achieve the above-described scheme, it is necessary to prepare two display devices. It is difficult to realize this system, for example, in a shop of a mass merchandiser for home electric appliances. Therefore, it is desirable to realize it within one display device.

However, in the case of the black frame insertion, it has been difficult to realize the above-described structure for the following reasons.

(1) Where the display device is driven at a frame frequency of 60 Hz based on the so-called NTSC standards and the black frame insertion is employed, it follows that the device is driven at a higher frequency.

(2) As a result of insertion of black frames, the brightness drops. Therefore, the brightness characteristics for the input video signal differs between when the device is driven while inserting black frames and when the device is driven normally.

(3) Strong flicker is felt as a result of motion of the line of sight at the boundary between the black inserted and normally driven regions.

### SUMMARY OF THE INVENTION

It is an object of the present invention to provide a display device capable of operating in a first mode in which the whole screen is driven by a black insertion method having excellent motion picture characteristics and in a second mode in which the whole screen is driven by a pseudo-normal drive method (i.e., the method consisting of (i) dividing the screen into plural display regions, (ii) driving one display region by the black insertion method, and (iii) driving another display region by a pseudo-normal method realizing a normal method, which does not use black insertion, in a pseudo manner.)

It is another object of the invention to provide a display device that homogenizes a gamma setting used in a black insertion method and a gamma setting used in a pseudo-normal drive method up to a level at which the human observer can no longer perceives any difference between them.

It is a further object of the invention to provide a display device which suppresses image quality deterioration (e.g., flicker arising from tracking of the line of sight) at the boundary regions between display regions driven by a black insertion method and display regions driven by a pseudo-normal drive method.

In the normal drive method referred to herein, the input frame frequency transferred to the display device from an external system is made equal to the output frame frequency transferred to the panel side of the display device for image display. In the pseudo-normal drive method referred to herein, the frame frequency is enhanced, for example, by doubling the output frame frequency relative to the input frame frequency. Also, in this drive method, the display brightness is not varied at every certain output frame frequency. In the black insertion method referred to herein, the output frame frequency is enhanced relative to the input frame frequency in the same way as in the pseudo-normal drive method. The display brightness is switched every output frame. This gives rise to a motion blur reduction effect. In the case of the hold-type display, the brightness characteristics in the time direction do not vary unless the video signal varies. Consequently, the observer's eye does not perceive any difference between the normal drive method and the pseudo-normal drive method.

The present invention lies in a display device which utilizes the black insertion method and which can operate in a pseudo-normal drive mode. In this mode, the whole screen is divided into plural display regions. One display region is driven by the black insertion method. Another display region is driven by a pseudo-normal drive method at the same output frame frequency as the frequency used in the black insertion method. To permit simultaneous comparisons, the video signal is converted for each region of the display device as the need arises such that gamma settings for both kinds of regions of the display device become equal.

Furthermore, a third region having a width of 2 or more pixels (preferably, 4 or more pixels) is formed in a boundary region between the black inserted region and the normally driven region. In the third region, an image is displayed at a brightness level equal either to the white level (maximum brightness) or to the black level (minimum brightness) for each color irrespective of the video signal.

According to the present invention, the display device can be operated in a first mode in which the whole screen is driven by the black insertion method providing excellent motion picture characteristics and also in a second mode different from the first mode. In the second mode, the whole screen is driven by a pseudo-normal drive method. That is, the whole screen is divided into plural display regions. One display region is driven by the black insertion method. The other display region is driven by a pseudo-normal drive method that realizes the normal drive method not using black insertion in a pseudo manner. In consequence, the difference in motion picture performance capabilities due to the different drive methods can be made to appeal to the observer.

According to the invention, the gamma setting used in the black insertion method and the gamma setting used in the pseudo-normal drive method are homogenized up to a level at which the observer no longer perceives any difference. Hence, the difference in motion picture performance capabilities due to the different drive methods can be made to appeal to the observer such that he/she does not get a feeling of oddness.

According to the invention, image quality deterioration (e.g., flicker caused by tracking of the line of sight) at the boundary region between the display region driven by the black insertion method and the display region driven by the pseudo-normal drive method can be suppressed. That is, the provision of the third region makes the brightness lower or higher than the brightness of each of the two display regions at all times even when the line of sight is moved across the boundary between the black inserted region and the pseudo-normally driven region. Consequently, the observer will perceive less flicker.

Other objects, features and advantages of the invention will become apparent from the following description of the embodiments of the invention taken in conjunction with the accompanying drawings.

### BRIEF DESCRIPTION OF THE DRAWINGS

FIG. 1 is a pictorial representation of a display screen in a demo mode.

FIG. 2 is a diagram showing the configuration of a display device.

FIG. 3 is a diagram illustrating timings at which display data is input into and output from a timing adjusting circuit 205.

FIG. 4 is a flowchart illustrating processing performed by a data conversion circuit 213.

FIG. 5 is a diagram illustrating the relationship between display data entered into each display region and output display data from the display region.

FIG. 6 is a diagram illustrating the relationship between display data that is input to each display region and relative brightness.

FIG. 7 is a pictorial representation of an image displayed on a display device in response to tracking of a line of sight.

FIG. 8 is a diagram representing the direction along which a line of sight tracks and brightness in a case where black insertion is not used.

FIG. 9 is a diagram representing the direction along which a line of sight tracks and brightness in a case where black insertion is used.

### DESCRIPTION OF THE INVENTION

A hold-type display device according to the present invention has a function of dividing one display screen into plural (e.g., 2, 3, or 4) screen regions which are different in motion picture performance. Gamma settings for the screen regions are set substantially equal to each other. The boundary region between the screen regions which are different in motion picture performance has a width of 2 or more pixels, as the need arises, at which at least each color shows a white level (maximum brightness level) or black level (minimum brightness level) irrespective of the video signal.

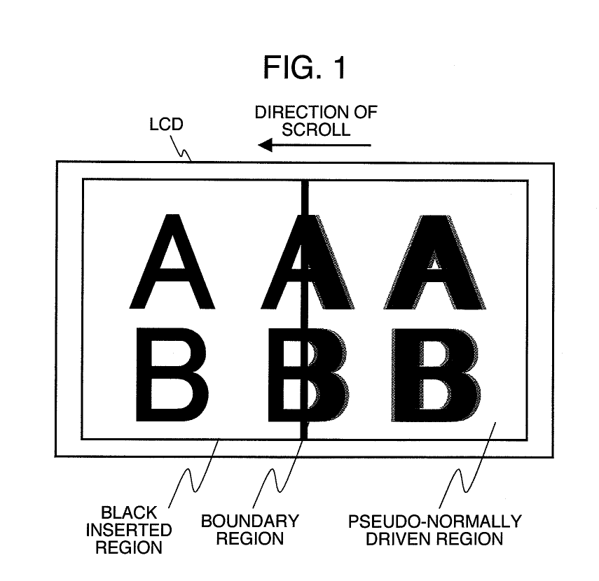

The mode in which the screen of the display is divided into the plural display regions and a black insertion method and a pseudo-normal drive method are respectively applied to the display regions is hereinafter referred to as the demo mode. Embodiments of the present invention are hereinafter described with reference to FIGS. 1-9.

FIG. 1 represents an image displayed on the display screen in the demo mode. In this embodiment, the display area of the hold-type display device is divided into two parts, i.e., left and right regions, nearly along the center of the display area. The left region is set as a black inserted region driven by the black insertion method. The right region is set as a pseudo-normally driven region. The central region of the display area is set as a boundary region forming a black line. The display area is divided into three parts in the left-and-right direction if the boundary region is included. Characters are scrolled from right to left across the screen. That is, motion picture display data for displaying characters moving from left to right is entered from an external system. Since it is only required that the user can recognize the difference in motion picture performance between the regions, the direction of division may be a left-and-right direction (direction of the scanning lines) or an up-and-down direction (direction of the data lines). Furthermore, the right region of the screen may be set as the black inserted region, and the left region may be set as the pseudo-normally driven region.

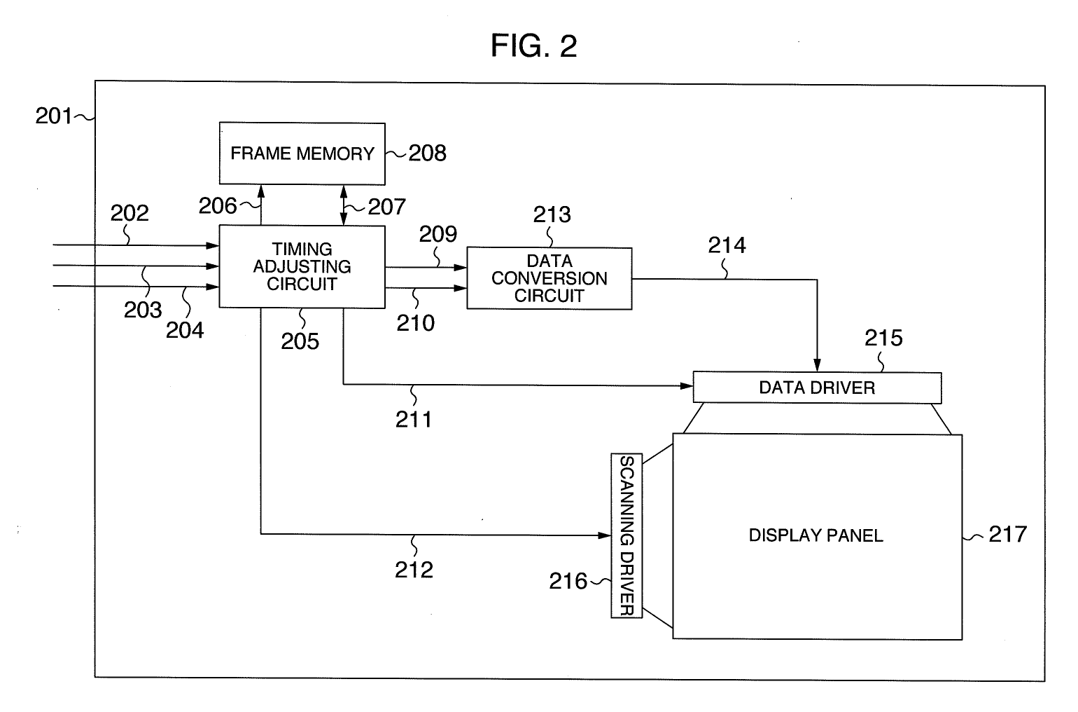

FIG. 2 is a diagram showing the configuration of the display device. The whole configuration of the display device is generally indicated by reference numeral 201. Also shown are a mode-setting signal 202, an input display data 203 indicating input video signal (the input video signal may also be indicated by 203), and an input timing signal 204. The mode-setting signal 202, input display data 203, and timing signal 204 are input signals from the external system (not shown). The mode of operation is switched by the mode-setting signal 202 among a mode (hereinafter referred to as the normal drive mode) in which the screen is not divided and the display panel is driven at a frequency synchronized with the input frequency, a black insertion mode in which the screen is not divided and the motion picture performance is enhanced, and the demo mode in which the screen is divided and the black insertion method and the pseudo-normal drive method are implemented at the same time.

The display device further includes a timing adjusting circuit (including a memory control circuit and a timing control circuit) 205, a memory control bus 206, a display data bus 207, and a frame memory 208 capable of storing one frame of display data. The frame memory 208 may also be a memory capable of storing more than one frame of display data or less than one frame of display data. The timing adjusting circuit 205 writes the display data 203 into the frame memory 208 as the need arises, based on the mode-setting signal 202. In the demo mode according to the present embodiment, one frame of display data is written into the frame memory 208 to realize the black insertion method and the pseudo-normal drive method within one frame of image at the same time. Furthermore, the display data is read from the frame memory 208 at a rate more than double the writing rate.

Also shown in FIG. 2 are the display data 209 read from the frame memory 208, a data conversion circuit control signal 210, a data driver control signal 211, a scanning driver control signal 212, and a data conversion circuit 213. Converted display data is indicated by 214. If necessary, the display data 209 is converted. The display device further includes a data driver 215, a scanning driver 216, and a display panel 217. The display panel 217 has plural data lines in the vertical direction and plural scanning lines in the horizontal direction. There are pixels at locations corresponding to the intersections of the data lines and scanning lines. The pixels are connected with the data lines and scanning lines. A grayscale voltage determined based on the display data 214 is transmitted to the pixels on the display panel 217 via the data lines by the data driver 215. The scanning driver 216 sequentially selects and scans the rows of the pixels on the display panel 217 in the vertical direction using the scanning line, based on the scanning driver control signal 212. As the grayscale voltage level of the data driver 215 relative to the selected rows varies, the brightness of the pixels on the display panel 217 varies, thus accomplishing a grayscale representation.

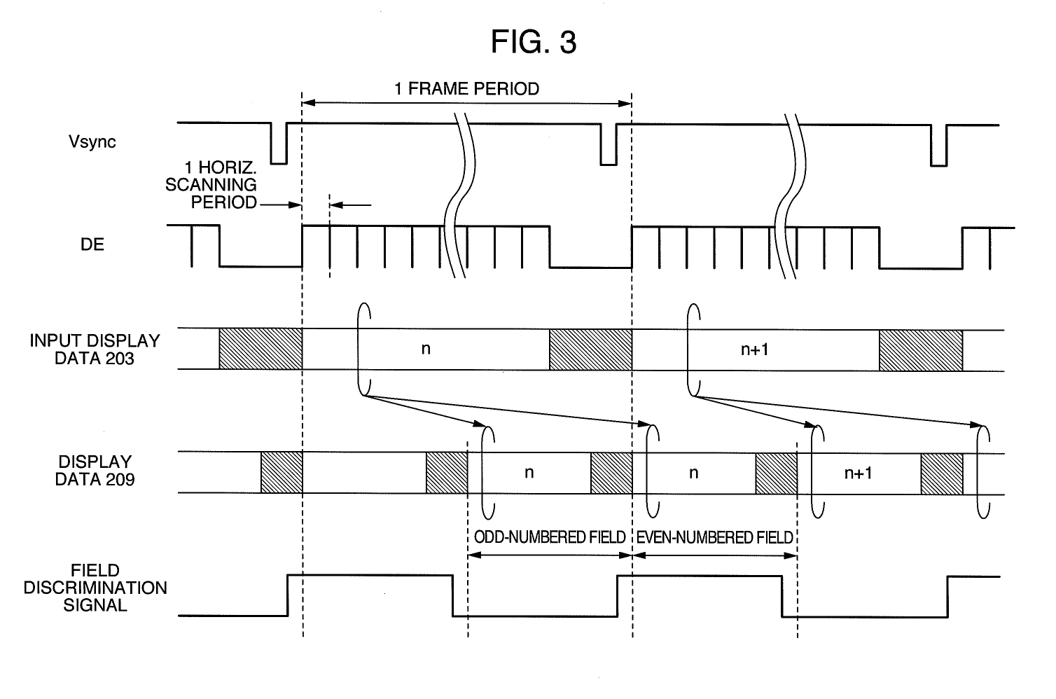

FIG. 3 is a diagram showing the timings at which display data is input to and output from the timing adjusting circuit 205. The input timing signal 204 has components Vsync and DE. The Vsync is a signal defining one frame period. DE is a signal defining an effective period of the input display data 203. One horizontal line of display data is transmitted during a period from an instant of time at which the DE goes high to an instant of time at which the DE goes high next. The data conversion circuit control signal 210 has a field discrimination signal as its one component. The discrimination signal is used to judge whether the data set is the first data set read out or the second data set read out after display data within one frame period has been read out twice.

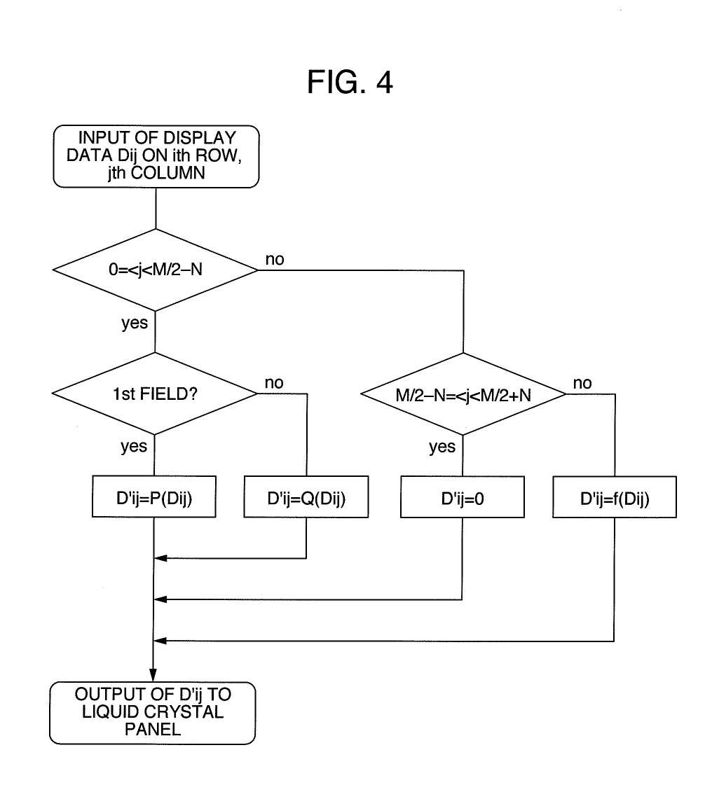

FIG. 4 is a flowchart illustrating processing performed by the data conversion circuit 213. The display panel 217 includes M columns of pixels. It is assumed that central N columns form a boundary region as shown in FIG. 1. The flowchart illustrates the flow of processing for creating display data D′ij (indicated by 214) from input display data Dij (indicated by 203) about a pixel at the ith row and jth column.

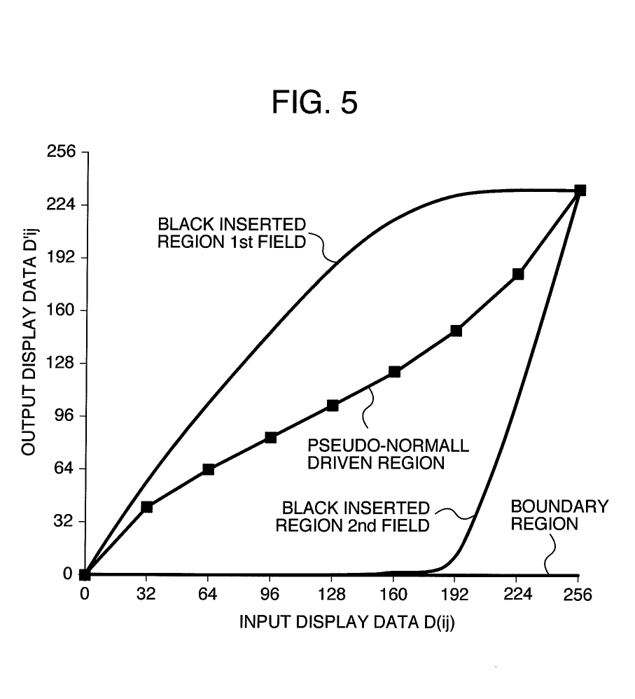

FIG. 5 is a diagram illustrating the relationship between input display data and output display data regarding the display regions. The horizontal axis indicates the input display data Dij, while the vertical axis indicates the output display data D′ij.

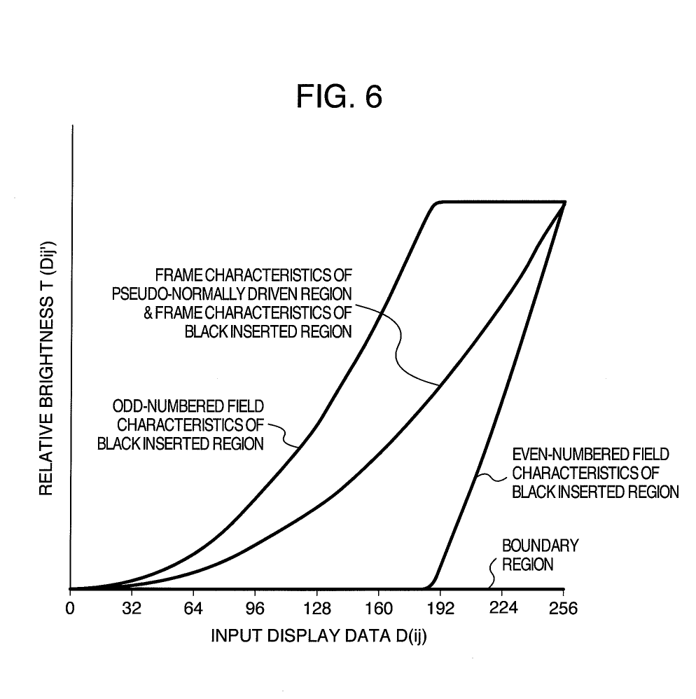

FIG. 6 is a diagram illustrating the relationship between the input display data and relative brightness regarding the display regions. The horizontal axis indicates the input display data Dij, whereas the vertical axis indicates the relative brightness T(D′ij) obtained by output display data D′ij that has been derived by converting the input display data Dij.

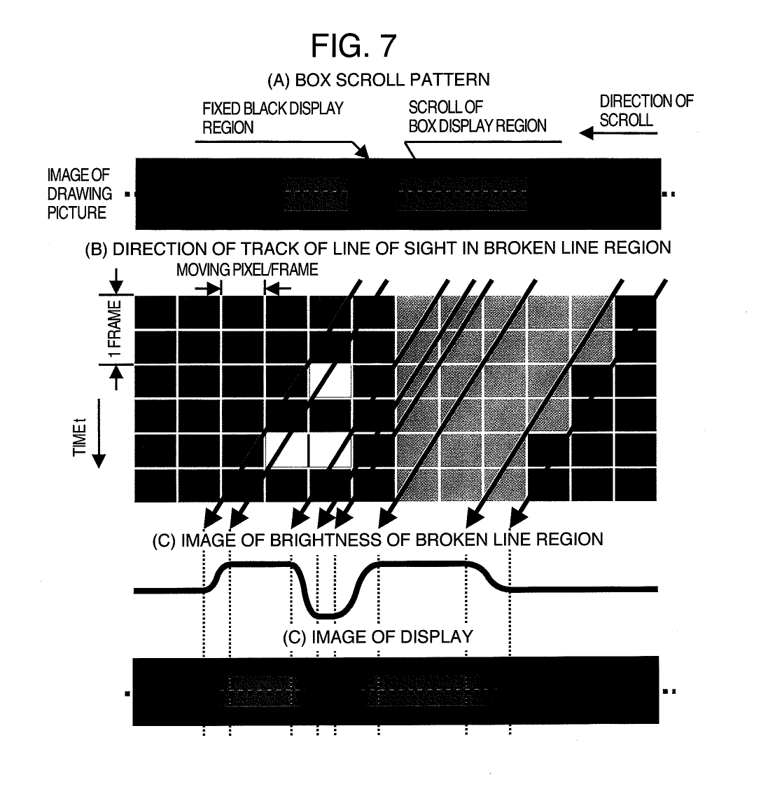

FIG. 7 represents an image of display provided when a line of sight performs tracking. Portion (A) of FIG. 7 indicates the case in which boxes are displayed on the screen at a bright halftone level against a background at a dark halftone level. The displayed boxes are moved horizontally from the pseudo-normally driven region on the right portion of the screen into the black frame inserted region in the left portion across the boundary region. It is assumed that if one displayed box moves into the black frame inserted region, another box appears from the right side of the screen in the same way. Portion (B) of FIG. 7 is a diagram showing variations of the brightness of the region indicated by the broken line in portion (A) occurring in the time-axis direction. The horizontal axis indicates the horizontal line across the display screen. The vertical axis indicates the time axis. Portion (C) of FIG. 7 is an image of brightness (pictorial representation of brightness) integrated as a line of sight is moved in synchronism with the speed of movement of the box displayed as shown in portion (B) of FIG. 7. Portion (D) of FIG. 7 is an image of visual observation (pictorial representation of visual observation) when the boxes shown as described so far are scrolled.

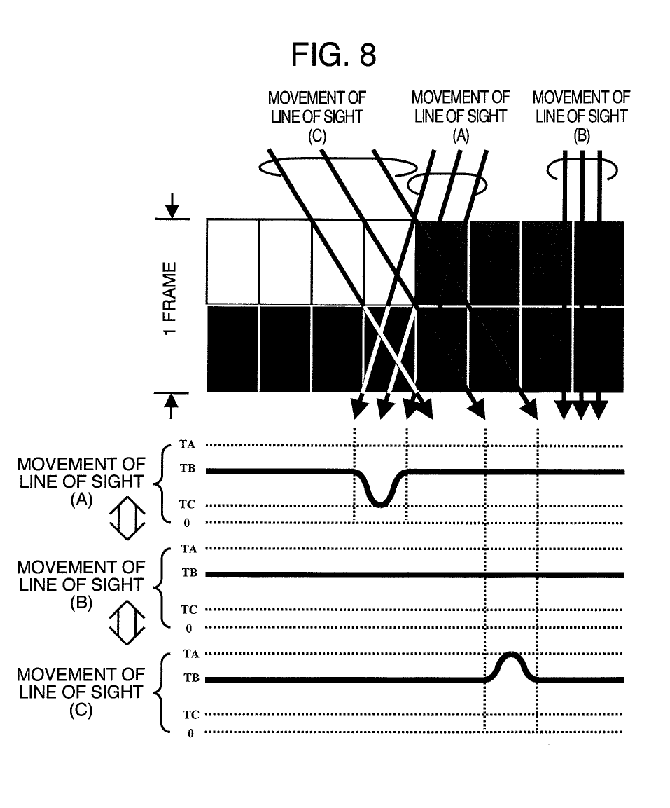

FIG. 8 shows the direction in which a line of sight performs tracking and a pictorial representation of brightness in a case where there is no boundary region. A portion corresponding to one frame shown in portion (B) of FIG. 7 has been taken in this FIG. 8. The arrow indicated along the movement of line of sight (A) indicates the direction of the line of sight in synchronism with the scrolled display pattern. Movement of line of sight (C) indicates the direction of movement of the line of sight when the line of sight is moved into the right region in order to observe the next box region. Movement of line of sight (B) indicates the direction of movement of an intermediate line of sight which makes a transition from the movement of line of sight (A) to movement of line of sight (C) or from movement of line of sight (C) to movement of line of sight (A).

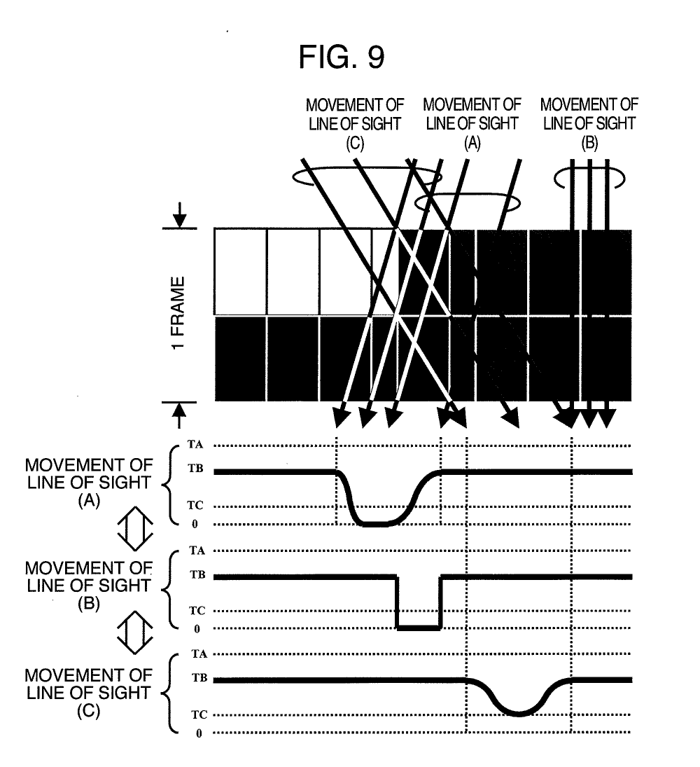

FIG. 9 is a diagram indicating the direction in which a line of sight performs tracking and providing a pictorial representation of brightness in a case where there is a boundary region. They have the same meanings as their counterparts in FIG. 8.

The operation of the embodiment is described in detail with reference to the above-referenced figures.

The mode-setting signal 202, input display data 203, and timing signal 204 are entered from the external system into the display device according to the present invention, as shown in FIG. 2. The mode-setting signal 202 selects a drive method according to its logical value, for example, from (i) a normal drive method for driving the display panel at the same frame frequency as the input frequency, (ii) a black insertion method for driving the panel at the double frequency and varying the display brightness every output frame, and (iii) the demo mode drive method according to the present embodiment. The present embodiment particularly pertains to the demo mode. In the following description, it is assumed that the demo mode has been selected. In this case, the input display data 203 is written into or read from the frame memory 208 via the timing adjusting circuit 205. For this read/write operation, one frame of display data indicating data within one frame period is written into the frame memory 208 as shown in FIG. 3. Data are read from the frame memory 208 in sequence twice. The first and second reading operations are referred to as 1st and 2nd fields, respectively. It is assumed that the fields can be discriminated using a field discrimination signal as shown in FIG. 3. The 1st and 2nd fields may have the same period of time. The period of the 1st field may be longer than the period of the 2nd field. Alternatively, the period of the 1st field may be shorter than the period of the 2nd field. The periods can be adjusted by controlling the timing at which the display data is read from the frame memory 208. Each period may be divided into 3 or more fields. The number of division for the fields can be adjusted by controlling the number of times that the display data is read from the frame memory 208. The fields referred to in the present embodiment are different from field signals of interlaced signals.

The display data 209 read from the frame memory 208 in this way is transferred to the data conversion circuit 213. The data conversion circuit 213 converts the display data 209 as illustrated in the flowchart of FIG. 4 to realize a display screen representation as shown in FIG. 1 when the display device operates in the demo mode, based on the data conversion circuit control signal 210 made up of the mode-setting signal 202, input timing signal 204, and field discrimination signal. More specifically, a boundary region consisting of N columns is formed in a central portion of the display panel 217 made up of M columns. The left portion of the screen is driven by the black insertion method. The right portion of the screen is driven by the pseudo-normal drive method.

The flow of this sequence of operations is described in further detail. Regions from the first column to the {(M−N)/2−1}th column in each row are driven by the black insertion method. In this case, a conversion given by D′ij=P (Dij) is performed using a conversion function based on the field discrimination signal if the field is the 1st field. If the field is the 2nd field, a conversion given by D′ij=Q (Dij) is performed using a different conversion function. It is assumed that with respect to display data about from the (M−N)/2th column in the central region to the {(M+N)/2−1}th column, the relationship D′ij=0 is set. For example, where the display data consists of 8 bits, all the bits are converted into 0. The value of 0 indicates that the brightness on the display panel assumes its minimum value. Consequently, black is displayed. With respect to the remaining regions, a conversion given by D′ij=f (Dij) is performed irrespective of whether the field is the 1st field or the 2nd field. Where white is displayed, if the display data consists of 8 bits, the relationship D′ij=255 is introduced for the display data about from the (M−N)/2th column to the {(M+N)/2−1}th column in the central region. That is, all the bits are converted into 1.

Conversion coefficients P and Q for the right region of the screen, i.e., the region driven by the black insertion method, are used to perform a conversion such that a larger value is obtained than the input display data for the 1st field, i.e., the brightness is increased as shown in FIG. 5. For the 2nd field, a conversion is performed such that a value smaller than the input display value is obtained, i.e., the brightness is reduced. At the same time, as the input display data is increased, the grayscale level is increased. This reduces the amount of increase in the conversion data D′ij for the 1st field. Conversely, the amount of increase in the conversion data D′ij for the 2nd field is increased. Finally, they reach the identical level. By driving the display device in this way, the 2nd field in the left portion of the screen is displayed black, especially at low grayscale levels. In this way, the black insertion can be accomplished. As a result, the relative brightness in each field of the left region of the screen driven by the black insertion method is as shown in FIG. 6. The brightness characteristics of the 1st field and the brightness characteristics of the 2nd field are alternately observed by the observer's eye. Consequently, the relationship between the display data and the brightness is converted into so-called gamma characteristics, generally a gamma value of 2.2. In the 1st field, a conversion given by D′ij=Q (Dij) may be performed using a conversion function. In the 2nd field, a conversion given by D′ij=P(Dij) may be performed using a conversion function. As a result of these conversions, the 1st and 2nd fields are inverted in brightness or darkness.

In the boundary regions, bits are converted into 0 at all times and so the relative brightness is 0 irrespective of the input display data. In the pseudo-normally driven region, a conversion given by D′ij=f (Dij) is performed. Because of this conversion, the gamma characteristics of the pseudo-normally driven region can be made coincident with the gamma characteristics of the black inserted region. That is, in a general case, the gamma value is set to 2.2.

It is now assumed that the relationship P (Dij)>=f (Dij)>=Q (Dij) holds. For example, (1) functions and driving voltages for P (Dij), Q (Dij) which give rise to the gamma value of 2.2 are determined from actual measurements. (2) Similarly, a driving voltage at f=1 (no conversion) giving rise to the gamma value of 2.2 is determined from actual measurements. (3) f (Dij) is determined such that the driving voltage of (2) is obtained under the conditions of the driving voltage of (1).

It is to be noted that the present embodiment provides the mode in which the user can more easily physically experience the effects of the drive method using black insertion. It is not necessary that the black inserted region and the pseudo-normally driven region be strictly coincident in gamma characteristics. Accordingly, for example, as shown in FIG. 5, a setting is made every 32 grayscale levels of the input display data consisting of 255 grayscale levels. The intermediate levels may be obtained by linear interpolation. As a result, as shown in FIG. 6, it may not be possible to bring the black inserted region and the pseudo-normally driven region into strict conformity in gamma setting. Because the left and right portions are intrinsically different in motion picture performance, a video signal such as broadcast waves can be displayed without producing a feeling of oddness.

The effects of the boundary region are next described. Portion (A) of FIG. 7 shows the manner in which a box pattern is scrolled from right to left across the screen. The line of sight of the observer moves as indicated by the arrows in portion (B) while tracking the normal box and the background boundary region. At the same time, in the demo mode, if the displayed box moves into the left region, or the black inserted region, of the screen to see difference in motion picture performance between the left and right portions, the observer moves the line of sight into the pseudo-normally driven region in the right portion of the screen to again check the difference in motion picture performance when the next box is displayed.

Where the boundary region is not provided, to perform an operation for returning the line of sight into the right portion of the screen from movement of line of sight (A) synchronized with the scrolling as shown in FIG. 8, the line of sight is moved to movement of the line of sight (C) via the movement of the light of sight (B) and then back to the movement of the line of sight (A) in this case. These operations are repeatedly carried out. With respect to the brightness characteristics observed on the screen at this time, the observed brightness is TB in a case where the tracking of the line of sight is completed only within the black inserted region or within the pseudo-normally driven region. In contrast, where the line of sight moves across the boundary between the black inserted region and the pseudo-normally driven region during the movement of line of sight (A), the former half field in response to one input frame becomes a pseudo-normally driven region. In the latter half field, the brightness of the region is lowered because of the black insertion driving method. These brightness levels are integrated as a retinal afterimage. Consequently, the brightness decreases to TC. Accordingly, in the case based on the movement of line of sight (A), the brightness of the boundary region is observed to be lower.

In contrast, where the movement of line of sight (B) occurs, the brightness is TB irrespective of the region. During the movement of line of sight (C), in the former half field, the brightness of the region is enhanced by the black insertion driving method. In the latter half field, the region is pseudo-normally driven. As a result, the brightness of the boundary region increases to TA. In consequence, whenever the line of sight is moved, the brightness or darkness of the boundary region varies. Since the frequency at which the brightness varies is low, the phenomenon is observed as flicker by the observer's eye.

In contrast, where the boundary region is provided, if this region is displayed black, for example, regardless of the input display data, the brightness in the vicinity of the boundary region is always lower than the brightness of the surroundings irrespective of whether the movement of line of sight is (A), (B), or (C) as shown in FIG. 9. Consequently, the observer perceives no flicker.

In this case, where the width of the movement of line of sight per frame is sufficiently smaller than the width of the boundary region, if the tilt of the movement of the line of sight, for example, in (C) of FIG. 9 becomes steeper, there is a possibility that the integrated brightness crosses the ascending region. Accordingly, we evaluated how difficult it was to detect the flicker caused by movement of the line of sight, using a liquid crystal display of 32-inch diagonal (81-cm diagonal) and with various values of the width of the boundary region displaying black and various values of display grayscale levels and scroll speed. The result was that where the width was 2 or more pixels, more preferably 4 or more pixels, feeling of oddness such as flicker was less perceived irrespective of the scroll speed and grayscale levels.

In the description provided so far, the operation for returning the line of sight to the original position at his/her own will to track the next scroll display is a factor producing flicker in the boundary region. It is also conceivable that movement of line of sight that is constant at all times may be hindered by quite small movements of the eyeball in practice. Flicker can be prevented by providing the boundary region of 2 pixel or more wide as in the present embodiment.

In the present embodiment, the boundary region is displayed black. Conversely, if the boundary region is displayed white, the boundary region is bright at all times and so similar effects can be anticipated. In addition, where each pixel is made up of, for example, RGB primary colors and the boundary region is displayed red by means of two pixels, for example, by displaying each pixel either as white or as black (i.e., each R pixel is set to a maximum brightness level, and each of G and B pixels is set to a minimum brightness level), similar effects can be anticipated. Further, the boundary region may be displayed at a white level and at a black level alternately at intervals of 1 to several fields or at intervals of 1 to several frames. Additionally, the boundary region may be set to a brightness level that is slightly lower than a white level or to a brightness level that is slightly higher than a black level. Instead of converting the display data about the boundary region, the supply of a grayscale voltage to data lines corresponding to the boundary region may be stopped. That is, in the boundary region, a display is provided at given brightness different from the display data.

Display devices utilizing the present technique can find use in television receivers, cell phones, computers, and so on which display motion pictures.

It should be further understood by those skilled in the art that although the foregoing description has been made on embodiments of the invention, the invention is not limited thereto and various changes and modifications may be made without departing from the spirit of the invention and the scope of the appended claims.

1. A display device for producing brightness corresponding to an externally applied video signal, wherein
(A) the display device can operate in a first mode in which a display area is divided into plural regions and the video signal is displayed and in a second mode in which the video signal is displayed without dividing the display area,
(B) in said first mode, the video signal that is singular is displayed over the whole display area,
(C) one frame period in which an amount of the video signal corresponding to one frame of image is displayed is divided into plural field periods,
(D) in each of the field periods, an amount of the video signal corresponding to one frame of image is displayed,
(E) in said first mode, (i) the video signal is displayed on one of the regions at a brightness level higher than a brightness level corresponding to the externally applied video signal during one of the field periods, (ii) the video signal is displayed on other one of the regions at a brightness level lower than the brightness level corresponding to the externally applied video signal during one of the field periods, and (iii) the video signal is displayed on other one of the regions at the brightness level corresponding to the externally applied video signal during one and other one of the field periods, and
(F) in said second mode, (i) the video signal is displayed at a brightness level higher than the brightness level corresponding to the externally applied video signal during one of the field periods and (ii) the video signal is displayed at a brightness level lower than the brightness level corresponding to the externally applied video signal during other one of the field periods or the video signal is displayed at the brightness level corresponding to the externally applied video signal during one and other one of the field periods.

2. A display device as set forth in claim 1,
wherein said externally applied video signal is displayed at a brightness level higher than the brightness level corresponding to the video signal during one of said field periods, and
wherein a difference between a gamma value used when the video signal is displayed at a brightness level lower than the brightness level corresponding to the externally applied video signal during other one of the field periods and a gamma value used when the video signal is displayed at the brightness level corresponding to the externally applied video signal during one and other one of the field periods is set to less than a given value.

3. A display device as set forth in claim 1, wherein a boundary region between said plural regions is displayed at a maximum or minimum brightness level.

4. A display device as set forth in claim 1, wherein mode of operation of the display device is switched between said first mode and said second mode in response to a control signal applied from outside.

5. A display device as set forth in claim 1, wherein said display area is divided in a horizontal direction in said first mode.

6. A display device as set forth in claim 1, further including:
a display panel on which plural pixels are arranged;
a memory capable of storing an amount of said externally applied video signal which corresponds to one or more frames of image;
a control circuit for controlling writing and reading of said video signal into and from said memory;
a conversion circuit for converting said video signal read from the memory;
a data driver for supplying a grayscale voltage corresponding to the converted video signal to said display panel; and
a scanning driver for selecting ones of said pixels to which said grayscale voltage is to be applied;
wherein said control circuit reads said video signal from the memory repeatedly a number of times corresponding to the number of the field periods at timings corresponding to the field periods; and
wherein in said first mode, said conversion circuit (i) converts said video signal, which corresponds to one of said plural regions and has been read out at a timing corresponding to one of the field periods, into a brightness level higher than the brightness level corresponding to the externally applied video signal and (ii) converts said video signal, which corresponds to one of said plural regions and has been read out at a timing corresponding to other one of the field periods, into a brightness level lower than the brightness level corresponding to the externally applied video signal.

7. A display device for producing brightness corresponding to an externally applied video signal, said display device comprising:
a display area divided into plural regions;
wherein said video signal that is singular is displayed over the whole display area;
wherein one frame period in which an amount of the video signal corresponding to one frame of image is displayed is divided into plural field periods;
wherein in each of the field periods, an amount of the video signal corresponding to one frame of image is displayed;
wherein (i) the video signal is displayed on one of the regions at a brightness level higher than a brightness level corresponding to the externally applied video signal during one of the field periods, (ii) the video signal is displayed at a brightness level lower than the brightness level corresponding to the externally applied video signal during other one of the field periods, and (iii) the video signal is displayed on other one of the regions at the brightness level corresponding to the externally applied video signal during one and other one of the field periods; and
wherein a difference between a gamma value used when the video signal is displayed on one of the regions and a gamma value used when the video signal is displayed on other one of the regions is set to less than a given value.

8. A display device as set forth in claim 7, wherein gamma characteristics used when the video signal is displayed on one of the regions and gamma characteristics used when the video signal is displayed on other one of the regions are made uniform.

9. A display device as set forth in claim 7, wherein a boundary region between said plural regions is displayed at a maximum or minimum brightness level.

10. A display device as set forth in claim 7, further including:
a display panel on which plural pixels are arranged;
a memory capable of storing an amount of said externally applied video signal which corresponds to one or more frames of image;
a control circuit for controlling writing and reading of said video signal into and from said memory;
a conversion circuit for converting said video signal read from the memory;
a data driver for supplying a grayscale voltage corresponding to the converted video signal to said display panel; and
a scanning driver for selecting ones of said pixels to which said grayscale voltage is to be applied;
wherein said control circuit reads said video signal from the memory repeatedly a number of times corresponding to the number of the field periods at timings corresponding to the field periods; and
wherein said conversion circuit (i) converts said video signal, which corresponds to one of said plural regions and has been read out at a timing corresponding to one of the field periods, into a brightness level higher than the brightness level corresponding to the externally applied video signal and based on a gamma value used when the video signal is displayed on one of the regions and (ii) converts said video signal, which corresponds to one of said plural regions and has been read out at a timing corresponding to other one of the field periods, into a brightness level lower than the brightness level corresponding to the externally applied video signal and based on the gamma value used when the video signal is displayed on the one of the regions.

11. A display device for producing brightness corresponding to an externally applied video signal, said display device comprising:
a display area divided into plural regions;
wherein said video signal that is singular is displayed over the whole display area;
wherein one frame period in which an amount of the video signal corresponding to one frame of image is displayed is divided into plural field periods;
wherein in each of the field periods, an amount of the video signal corresponding to one frame of image is displayed;
wherein (i) the video signal is displayed on one of the regions at a brightness level higher than a brightness level corresponding to the externally applied video signal during one of the field periods, (ii) the video signal is displayed at a brightness level lower than the brightness level corresponding to the externally applied video signal during other one of the field periods, and (iii) the video signal is displayed on other one of the regions at the brightness level corresponding to the externally applied video signal during one and other one of the field periods; and
wherein a boundary region between said plural regions is displayed at a given brightness level irrespective of said externally applied video signal.

12. A display device as set forth in claim 11, wherein said given brightness level is a maximum or minimum brightness level.

13. A display device as set forth in claim 11, wherein said boundary region has a width of two or more pixels.

14. A display device as set forth in claim 11, further including:
a display panel on which plural pixels are arranged;
a memory capable of storing an amount of said externally applied video signal which corresponds to one or more frames of image;
a control circuit for controlling writing and reading of said video signal into and from said memory;
a conversion circuit for converting said video signal read from the memory;
a data driver for supplying a grayscale voltage corresponding to the converted video signal to said display panel; and
a scanning driver for selecting ones of said pixels to which said grayscale voltage is to be applied;
wherein said control circuit reads said video signal from the memory repeatedly a number of times corresponding to the number of the field periods at timings corresponding to the field periods; and
wherein said conversion circuit (i) converts said video signal, which corresponds to one of said plural regions and has been read out at a timing corresponding to one of the field periods, into a brightness level higher than the brightness level corresponding to the externally applied video signal, (ii) converts said video signal, which corresponds to said boundary region and has been read out at a timing corresponding to one of the field periods, into said given brightness level, (iii) converts said video signal, which corresponds to the boundary region and has been read out at a timing corresponding to other one of the field periods, into said given brightness level, and (iv) converts said video signal, which corresponds to one of said plural regions and has been read out at a timing corresponding to other one of the field periods, into a brightness level lower than the brightness level corresponding to the externally applied video signal.

15. A display device for producing brightness corresponding to an externally applied video signal, said display device comprising:
a display panel on which plural pixels are arranged;
a memory capable of storing an amount of said video signal which corresponds to one or more frames of image;
a control circuit for controlling writing and reading of said video signal into and from said memory;
a conversion circuit for converting said video signal read from the memory;
a data driver for supplying a grayscale voltage corresponding to the converted video signal to said display panel; and
a scanning driver for selecting ones of said pixels to which said grayscale voltage is to be applied;
wherein a display area of said display panel is divided into plural regions;
wherein said video signal that is singular is displayed over the whole display area;
wherein one frame period in which an amount of the video signal corresponding to one frame of image is displayed is divided into plural field periods;
wherein in each of the field periods, an amount of the video signal corresponding to one frame of image is displayed;
wherein (i) the video signal is displayed on one of the regions at a brightness level higher than a brightness level corresponding to the externally applied video signal during one of the field periods, (ii) the video signal is displayed at a brightness level lower than the brightness level corresponding to the externally applied video signal during other one of the field periods, and (iii) the video signal is displayed on other one of the regions at the brightness level corresponding to the externally applied video signal during one and other one of the field periods;
wherein said control circuit reads said video signal from said memory repeatedly a number of times corresponding to the number of the field periods at timings corresponding to the field periods; and
wherein said conversion circuit (i) converts said video signal, which corresponds to one of said plural regions and has been read out at a timing corresponding to one of the field periods, into a brightness level higher than the brightness level corresponding to the externally applied video signal and (ii) converts said video signal, which corresponds to one of said regions and has been read out at a timing corresponding to other one of the field periods, into a brightness level lower than the brightness level corresponding to the externally applied video signal.
